(19) United States
(12) Patent Application Publication
(10) Pub. No.: US 2026/0035563 A1
(43) Pub. Date: Feb. 5, 2026

(54) POLYSILOXANE FILLER TREATING AGENT AND COMPOSITIONS PREPARED THEREWITH

(71) Applicants: Dow Global Technologies LLC, Midland, MI (US); Rohm and Haas Company, Collegeville, PA (US); Dow Silicones Corporation, Midland, MI (US)

(72) Inventors: Matthew Carter, Bala Cynwyd, PA (US); Hai Wang, Royersford, PA (US); Hongyun Xu, Midland, MI (US); Dan Zhao, Midland, MI (US); Elena Montoto Blanco, Chicago, IL (US); Tzu-Chi Kuo, Midland, MI (US)

(21) Appl. No.: 18/996,277

(22) PCT Filed: Aug. 4, 2023
(86) PCT No.: PCT/US2023/071638

§ 371 Date: Jan. 17, 2025

Related U.S. Application Data
(60) Provisional application No. 63/396,015, filed on Aug. 8, 2022.

(51) Int. Cl. C08L 83/10; C08K 3/22; C09C 1/40; C09C 3/12

(52) U.S. Cl. CPC C08L 83/10; C08K 3/22; C09C 1/407; C09C 3/12; C01P 2004/53; C01P 2006/32; C08K 2003/2227; C08K 2201/001; C08K 2201/005; C08K 2201/014; C08L 2205/025

(57) ABSTRACT

The present invention relates to a composition comprising a) a polyorganosiloxane; b) filler particles; and c) a filler treating agent of Formula (I): (I) where R¹, R^{1′}, R², R^{2′}, m, n, p, and q are as defined herein. The composition is useful as a thermally conductive formulation.

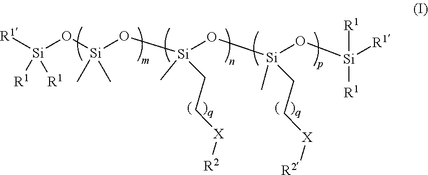

### BACKGROUND OF THE INVENTION

The present invention relates to a polysiloxane-based filler treating agent and its application in thermally conductive formulations.

Increased demand for conductive composite materials is driving the discovery of thermally conductive formulations that provide more uniform and more efficient heat dissipation from integrated circuits, battery packs, microelectronic circuitry, and electric motors. The major components of conventional thermally conductive formulations are a matrix polymer, inorganic filler particles, and a filler treating agent (FTA). The inorganic particles are the least expensive component in a thermally conductive formulation and provide heat dissipation. It is desirable, therefore, to load and uniformly disperse high levels of filler particles into the matrix polymer; uniform dispersion is challenging, however, because the filler particles are generally incompatible with the matrix polymer, resulting in phase separation. FTAs, which have chemical functionalities compatible with both the matrix polymer and the filler particles promote compatibility and improve the dispersability of filler particles with the matrix by associating with the surface of the inorganic particles. Examples of commercially available FTAs are monotrimethoxysilyloxy-terminated polydimethylsiloxanes, represented by the following formula:

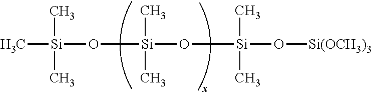

(See U.S. Pat. No. 7,592,383 B2, column 6). Unfortunately, while this class, as well as other structurally similar FTAs are high performing, they are extremely costly because they are prepared by multistep synthetic procedures that require the use of toxic reagents and solvents, and a host of purification steps. It would therefore be an advantage in the art of compatibilizing agents for thermally conductive formulations to discover a relatively low-cost FTA that has acceptable performance properties, including squeeze flow, extrusion rate, and viscosity.

### SUMMARY OF THE INVENTION

The present invention addresses a need in the art by providing a composition comprising:
a) a polyorganosiloxane;
b) filler particles; and
c) a filler treating agent of Formula I:

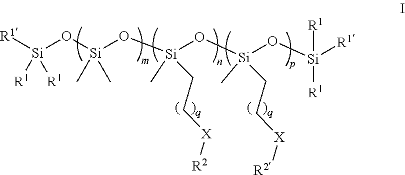

where m is from 5 to 150; n is from 0.1 to 5; p is from 0 to 5; q is from 1 to 6; X is S or NR⁶; each R¹ is independently C₁-C₆-alkyl, vinyl, phenyl, or benzyl; each R^{1′} is independently C₁-C₆-alkyl;
R² is:

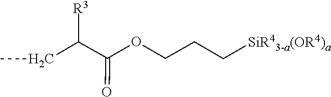

R^{2′} is:

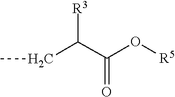

where R³ is H or methyl; each R⁴ is independently C₁-C₆-alkyl; a is an integer of 1 to 3; R⁵ is C₁-C₁₂-alkyl, R⁶ is H or C₁-C₆ alkyl, and the dashed line represents the point of attachment to X; wherein the polyorganosiloxane has degree of polymerization in the range of from 40 to 800.

The composition of the present invention is useful as a thermally conductive formulation.

### DETAILED DESCRIPTION OF THE INVENTION

The present invention is a composition comprising:
a) a polyorganosiloxane;
b) filler particles; and
c) a filler treating agent of Formula I:

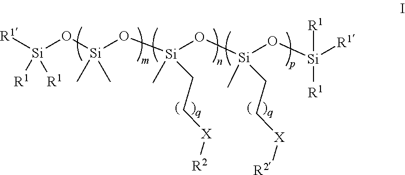

where m is from 5 to 150; n is from 0.1 to 5; p is from 0 to 5; q is from 1 to 6; X is S or NR⁶; each R¹ is independently C₁-C₆-alkyl, vinyl, phenyl, or benzyl; each R^{1′} is independently C₁-C₆-alkyl;
R² is:

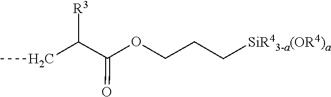

R^{2′} is:

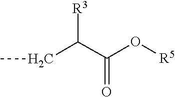

where R³ is H or methyl; each R⁴ is independently C₁-C₆-alkyl; a is an integer of 1 to 3; R⁵ is C₁-C₁₂-alkyl, R⁶ is H or C₁-C₆ alkyl, and the dashed line represents the point of attachment to X; wherein the polyorganosiloxane has degree of polymerization in the range of from 40 to 800.

The FTA of Formula I is a random copolymer; that is to say, the structural units with subscripts m, n, and p need not be in the order depicted in Formula I. Preferably m is from 20 or from 50, to preferably 125; preferably, n is from 0.5 or from 1 or from 1.2 or from 1.5, to 5 or to 3 or to 2; p is from 0 or from 0.3 or from 0.5, to 5 or to 3 or to 2 or to 1; q is from 1 or from 2 to 6 or to 4; each R¹ is preferably independently C₁-C₆-alkyl, more preferably methyl or ethyl, and most preferably methyl; R³ is preferably H; R⁴ is preferably methyl or ethyl, more preferably methyl; a is preferably 2 or 3. Examples of suitable R⁵ groups include methyl, ethyl, n-butyl, t-butyl, n-hexyl, 2-ethylhexyl, and n-octyl groups. R⁶ is preferably H or methyl, more preferably H.

The filler treating agent used in the composition of the present invention may be prepared by contacting a compound of Formula Ia:

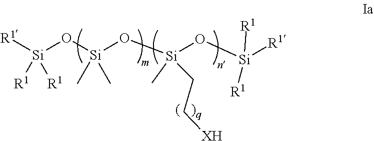

with an acrylate or methacrylate of Formula Ib:

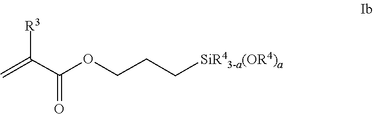

in the presence of a coupling catalyst such as dimethylphenyl phospine to prepare the compound of Formula I, where p is 0; and n′ is 0.1 to 10.

Alternatively, the compound of Formula Ia can be contacted under the same conditions with the compound of Formula Ib and a compound of Formula Ic:

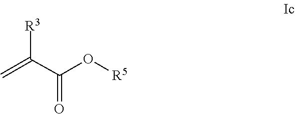

to form a compound of Formula I, where p is >0.

The polyorganosiloxane may be functionalized with, for example, one or more crosslinkable groups, such as terminal vinyl groups. Examples of such functionalized polyorganosiloxanes include monovinyl-di-C₁-C₆-alkyl terminated polysiloxane and bis(vinyl-di-C₁-C₆-alkyl) terminated polysiloxane, more particularly his(vinyl-dimethyl) terminated polysiloxane, which can be prepared as described in U.S. Pat. No. 4,329,273.

The filler particles are metal, metal oxide, metal hydrate, or ceramic nitride particles such as aluminum, aluminum oxide (alumina), aluminum trihydrate, boron nitride, or zinc oxide particles. The D₅₀ particle size of the filler particles, as determined using a HELOS laser diffraction device, is typically in the range of from 0.5 μm to 100 μm. A multimodal (e.g., bimodal) distribution of first and second filler particles may be used in the formulation to boost filler particle concentration.

The polyorganosiloxane concentration is preferably in the range of from 1.9 or from 5 wt. % to 15 or to 10 wt. %, based on the weight of the composition; the FTA concentration is preferably in the range of from 0.1 or from 0.2 or from 0.3 wt. %, to 3 or to 1 or to 0.7 or to 0.5 wt. %, based on the weight of the composition; and the filler loading is preferably in the range of from 70 or from 80 or from 85 or from 90 wt. % to 98 or to 94 wt. %, based on the weight of the composition.

The formulated composition of the present invention has been found to have a favorable squeeze flow rate, viscosity, extrusion rate, and thermal conductivity.

### EXAMPLES

### Size Exclusion Chromatography Method

SEC separations were performed on a liquid chromatograph with an Agilent 1260 Infinity II isocratic pump, multicolumn thermostat, integrated degasser, autosampler, and refractive index detector. The system was equipped with two PLgel Mixed A columns (300×7.5 mm i.d., particle size=20 μm) and a guard column (50×7.5 mm i.d.). The column oven and the refractive index detector operated at 40° C. The sample injection volume was 100 μL and separations were performed with THE as the eluent at a flow rate of 1.0 m/min. The instrument was calibrated with ten narrow-dispersity polystyrene standards from 580-371,000 Da. Data analysis was carried out using the Agilent GPC/SEC software package version A.02.01 (Build 9.34851).

### NMR Spectroscopy Method

NMR spectroscopy was performed using a Bruker Avance III HD 500 spectrometer equipped with a 5-mm Prodigy BBO CryoProbe (Billerica, MA). Proton spectra were acquired with a pulse repetition delay of 10 s. Chemical shifts are reported relative to the residual solvent protons of CDCl₃ (δ ¹H, 7.26 ppm).

### Example A—General Method for Preparing Sulfide Linked FTAs

GP-71-SS Mercapto functional silicone fluid (15.0 g, 4.5 mmol SH functionality, MW=6600 g/mol, dp=83 for Comparative Example 1 and Examples 1-5), 3-(trimethoxysilyl)propyl acrylate (TMSiPA) only for Example 1 or a mixture of TMPSiPA and butyl acrylate (BA) or octyl acrylate (OA) for Examples 2-5 (4.5 mmol total acrylate functionality in all cases), and dimethylphenyl phosphine (6.2 mg, 0.045 mmol) were weighed into a capped glass vial; the headspace was purged with nitrogen. The reaction mixture was mixed by a vortex mixer for 30 min and then held at room temperature for 24 h. The reaction mixture was then purified by gravity filtration through a plug of neutral alumina (2 g). The product was characterized by SEC and proton NMR spectroscopy. For Examples 6 and 7, GP-800 Mercapto functional silicone fluid (15.0 g, 9.1 mmol SH functionality, MW=8400 g/mol, dp=108) and an acrylate or a mixture of acrylates (9.1 mmol acrylate functionality), and dimethylphenyl phosphine (0.091 mmol) were used.

### Example B—General Method for Preparing Amine Linked FTAs

GP-6 Amino functional silicone fluid (15.0 g, 7.5 mmol NH₂ functionality, MW=7900 g/mol, dp=100), TMSiPA (1.8 g, 7.5 mmol) for Example 8 or a mixture of TMSiPA (0.88 g, 0.375 mmol) and OA (0.69 g, 0.375 mmol) for Example 9 were weighed into a capped glass vial; the headspace was purged with nitrogen. GP-4 Amino functional silicone fluid (15.0 g, 12.8 mmol NH₂ functionality, MW=4800 g/mol, dp=58), a mixture of TMSiPA (1.5 g, 6.4 mmol) and OA (1.2 g, 6.4 mmol) for Example 10 were weighed into a capped glass vial; the headspace was purged with nitrogen. The reaction mixture was mixed by a vortex mixer for 30 min and then held at 100° C. for 2 h. The reaction mixture was then purified by gravity filtration through a plug of neutral alumina (2 g). The product was characterized by SEC and proton NMR spectroscopy.

Table 1 provides a summary of the starting materials and the mole:mole ratios of TMPSiPA:BA or TMPSiPA:OA, where applicable, for Comparative Example 1 and Examples 1-10.

TABLE 1
Starting Material Molar Ratios for FTA samples

| Ex# | Silicone | mole ratio |
|---|---|---|
| C1 | GP-71-SS | OA only; No added TMSiPA |
| 1 | | No added OA or BA |
| 2 | | TMSiPA:OA = 3:1 |
| 3 | | TMSiPA:OA = 1:1 |
| 4 | | TMSiPA:BA = 3:1 |
| 5 | | TMSiPA:BA = 1:1 |
| 6 | GP-800 | TMSiPA:OA = 2.86:1 |
| 7 | | TMSiPA:OA = 0.59:1 |
| 8 | GP-6 | No added OA or BA |
| 9 | | TMSiPA:OA = 1:1 |
| 10 | GP-4 | TMSIPA:OA = 1:1 |

### Examples 1-10—General Procedure for Preparation of Formulations with Alumina Filler

FTA samples (0.16 g) and a bis-vinyl-terminated polysiloxane (2.80 g, viscosity=60 mP·s) were first speed-mixed in a Max-40 mixer cup at 2000 rpm for 30 s. This pre-mixed fluid (2.96 g) was then combined with Al-43-BE Alumina particles (17.02 g; D₅₀=1-2 μm) and speed-mixed at 1300 rpm for 30 s. CB-A20S Alumina particles (17.02 g; D₅₀=50 μm) were then added to the formulation and speed-mixed at 1300 rpm for 30 s. The resultant fully formulated thermal gel was then hand-mixed, speed-mixed again at 1300 rpm for 30 s and transferred to a glass jar and heated at 150° C. under vacuum for 1 h.

### Measurement of Squeeze Flow

A squeeze-flow test was used to characterize the flowability of the test formulations containing FTA samples as follows: The thermally conductive test formulation (0.6 g) was sandwiched between two glass slides (25×7 5×1.0 mm, obtained from Thermofisher) and separated by two 1-mm shims to control the thickness. The top glass slide was manually pressed down to ensure a uniform spread of the material, and the initial diameter of the material was recorded as D₁. The 1-mm spacers were then removed from the test sample, and a 350-g mass was placed on the top glass and allowed to stand for 1 min. The post-squeeze diameter was recorded as D₂ and the squeeze flow was calculated as ΔR=(D₂−D₁)/2 (mm).

### Measurement of Viscosity at 0.1% Strain

An oscillatory shear strain amplitude sweep was performed on the test formulation samples to characterize the formulation viscosity and the shear thinning behavior. The test formulation samples are loaded onto the Anton Paar High Throughput Rheometer (AP HT Rheometer) using 25-mm parallel plate geometry. Trimming was performed at 1.0-mm gap with the automatic trimming robot. After a 300-s pre-test soaking time, the measurements were taken using the standard procedure of 10 rad/s oscillation frequency, sweeping from 0.01 to 300% strain amplitude with 20 sampling points per decade. Viscosity at 0.1% strain (low shear rate viscosity) was reported.

### Measurement of Extrusion Rate

Extrusion rates were measured by loading the gel formulations into a 30-mL EFD syringe. The syringe was then attached to the EFD dispensing apparatus and material was dispensed at 55 Psi under nitrogen for 5 s. The extrusion rate was recorded as the mass dispensed during the 5-s dispensing period, as determined using an analytical balance.

Thermal conductivity Measurements

Thermal conductivity was measured using a Hot Disk transient plane source tool (TPS 2500S) and a Kapton-encased thermal probe. Isotropic bulk measurements were performed on 6 mm diameter vessels.

Table 2 illustrates Squeeze flow (S.F, in mm), Viscosity @0.1% strain (Visc., in Pa·s) and Extrusion rate at 55 psi (E.R., in g/5 s) for the thermal gel samples.

All FTAs were prepared substantially as described in Examples A and B except for varying the mole ratios of TMSiPA and BA, or TMSiPA and OA. In Table 2, TMSiPA_{M} refers to the relative moles of TMPSiPA versus moles of BA or OA used to prepare the samples. R⁵ is either octyl or butyl, as indicated. DP refers to the degree of polymerization of the FTA.

RMS-759 refers to DOWSIL™ RMS-759 Mono-trimethoxysiloxy-dimethylsiloxane Polymer (A Trademark of The Dow Chemical Company or its Affiliates), which is the FTA used in Comparative Example 2. The thermal conductivity of the comparative gel formulation containing RMS-759 was measured at 3.02 W/m·K; the thermal conductivity of the example formulations was in the range of 2.8 and 3.0 W/m·K. S.F., Visc., and E.R. could not be measured for C1 (N.M.) because no flowable formulation was obtained.

TABLE 2
Properties of Thermal Gel Samples

| Ex# | DP | X | TMPSiPA_{M} | R⁵ | R^{2′}_{M} | S.F. | Visc. | E.R. |
|---|---|---|---|---|---|---|---|---|
| C1 | 83 | S | 0 | n-octyl | 2 | N.M. | N.M. | N.M. |
| 1 | | | 2 | — | 0 | 9.5 | 715 | 3.2 |
| 2 | | | 1.5 | n-octyl | 0.5 | 7.8 | 652 | 3.4 |
| 3 | | | 1 | n-octyl | 1 | 7.8 | 761 | 3.4 |
| 4 | | | 1.5 | n-butyl | 0.5 | 7.0 | 1098 | 3.4 |
| 5 | | | 1 | n-butyl | 1 | 6.3 | 1509 | 3.4 |
| 6 | 108 | | 4 | n-octyl | 1.4 | 4.5 | 5619 | 2.8 |
| 7 | | | 2 | n-octyl | 3.4 | 4.8 | 4249 | 2.0 |
| 8 | 100 | NH | 4 | — | 0 | 3.8 | 28200 | 2.1 |
| 9 | | | 2 | n-octyl | 2 | 4.5 | 26250 | 1.7 |
| 10 | 58 | | 2 | n-octyl | 2 | 3.8 | 18040 | 1.8 |

| | | | | |
|---|---|---|---|---|
| C2 | FTA = RMS-759 | 8.0 | 64.9 | 1.4 |

Example 1-10 formulations all exhibited acceptable squeeze flows, viscosities @0.1% strain, extrusion rates, and thermal conductivity. Extrusion rates were significantly improved as compared with the commercial formulation (C2), as were viscosities @0.1% strain. Higher viscosities are advantageous for attenuating settling of the filler in the composition. The formulations of the present invention also benefit from the ease of preparation of the FTAs, and the flexibility in tuning the properties of interest.

1. A composition comprising:
a) a polyorganosiloxane;
b) filler particles; and
c) a filler treating agent of Formula I: 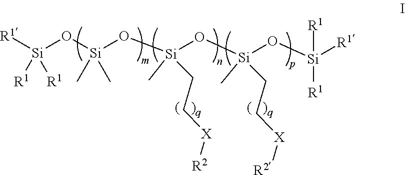
where m is from 5 to 150; n is from 0.1 to 5; p is from 0 to 5; q is from 1 to 6; X is S or NR⁶; each R¹ is independently C₁-C₆-alkyl, vinyl, phenyl, or benzyl; each R^{1′} is independently C₁-C₆-alkyl;
R² is: 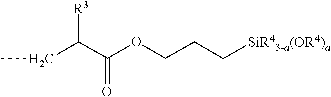
R^{2′} is: 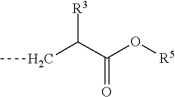
where R³ is H or methyl; each R⁴ is independently C₁-C₆-alkyl; a is an integer of 1 to 3; R⁵ is C₁-C₁₂-alkyl, R⁶ is H or C₁-C₆ alkyl, and the dashed line represents the point of attachment to X;
wherein the polyorganosiloxane has degree of polymerization in the range of from 40 to 800.

2. The composition of claim 1 wherein, based on the weight of the composition, the concentration of the polyorganosiloxane is in the range of from 1.9 to 15 wt. %, the concentration of the filler particles is in the range of from 70 to 98 wt. %, and the concentration of the filler treating agent of Formula I is in the range of from 0.1 to 3 wt %; wherein the filler particles are aluminum, alumina, aluminum trihydrate, boron nitride, or zinc oxide particles.

3. The composition of claim 2 wherein each R¹ is independently C₁-C₆-alkyl; n is from 1 to 3; p is from 0 to 2; q is from 2 to 4; each R¹ is independently C₁-C₆-alkyl; and a is 2 or 3; where the filler particles are alumina at a concentration in the range of from 85 to 94 wt %, based on the weight of the composition.

4. The composition of claim 3 wherein where each R¹ is independently methyl or ethyl; R⁵ is methyl, ethyl, n-butyl, t-butyl, n-hexyl, 2-ethylhexyl, or n-octyl; R³ is H; and q is 2.

5. The composition of claim 4 wherein each R¹ is methyl; R⁵ is methyl, ethyl, n-butyl, t-butyl, n-hexyl, 2-ethylhexyl, or n-octyl; wherein the polyorganosiloxane is a bis(vinyl-di-C₁-C₆-alkyl) terminated polysiloxane.

6. The composition of claim 5 where R⁵ is n-butyl or n-octyl; n is 2; p is 0; wherein the vinyl-functionalized polyorganosiloxane is a bis(vinyl-dimethyl) terminated polysiloxane; where the alumina filler particles have a bimodal distribution.

7. The composition of claim 1 where X is S.

8. The composition of claim 1 where X is N, and R⁶ is H.
